(19) United States
(12) Patent Application Publication
(10) Pub. No.: US 2018/0191461 A1
(43) Pub. Date: Jul. 5, 2018

(54) Interface Data Transmission Method, Data Transmission Interface, and Interface System

(71) Applicant: Huawei Technologies Co., Ltd., Shenzhen (CN)

(72) Inventors: Xuguang Li, Shanghai (CN); Guangwei Zheng, Shanghai (CN)

(21) Appl. No.: 15/855,670

(22) Filed: Dec. 27, 2017

(30) Foreign Application Priority Data
Dec. 31, 2016 (CN) 201611261975.5

(51) Int. Cl. H04L 1/00

(52) U.S. Cl. CPC H04L 1/0033; H04L 1/0008

(57) ABSTRACT

An interface data transmission method, a data transmission interface, and an interface system, where the method includes encoding, by a transmit end in the interface system, original data to obtain encoded data, where the encoding operation includes grouping the original data, the encoded data includes a termination code block indicating that a transmission process of the original data terminates, and the termination code block includes a first synchronization header, a code block type field indicating that the transmission process terminates, and a termination payload, and the first synchronization header indicates that a payload following the first synchronization header includes a control-type payload, and the termination payload may be used to carry a remaining code block after the original data is grouped, and sending, by the transmit end, the encoded data to a receive end.

### CROSS-REFERENCE TO RELATED APPLICATIONS

This application claims priority to Chinese Patent Application No. 201611261975.5 filed on Dec. 31, 2016, which is hereby incorporated by reference in its entirety.

### TECHNICAL FIELD

This application relates to the field of interface data technologies, and in particular, to an interface data transmission method, a data transmission interface, and an interface system.

### BACKGROUND

In a terminal device, when data transmission is performed between a baseband chip and a radio frequency chip using respective data transmission interfaces, a transmit end needs to encode to-be-sent original data. Therefore, encoded data obtained after the transmit end encodes the to-be-sent original data includes both the original data and a control code block added in the encoding process. In this case, after receiving the encoded data, a receive end needs to delimit a start and stop location of the original data in the encoded data in order to restore the original data from the encoded data. The transmit end may be the radio frequency chip or the baseband chip, and the receive end may be the baseband chip or the radio frequency chip. That is, when the transmit end is the radio frequency chip, the receive end is the baseband chip, or when the transmit end is the baseband chip, the receive end is the radio frequency chip.

To sum up, when interface data transmission is performed between the baseband chip and the radio frequency chip, a better interface data transmission mode is urgently required to delimit the start and stop location of the original data in the encoded data.

### SUMMARY

Embodiments of this application provide an interface data transmission method, a data transmission interface, and an interface system in order to delimit a start and stop location of original data in encoded data.

According to a first aspect, an embodiment of this application provides a method for sending interface data, where the method includes encoding, by a transmit end, original data to obtain encoded data, where the encoding operation of the transmit end includes grouping the original data, and sending, by the transmit end, the encoded data to a receive end in an interface system, where the encoded data includes a termination code block, the termination code block may be used to indicate that a transmission process of the original data terminates, and the termination code block includes a first synchronization header, a code block type field indicating that the transmission process terminates, and a termination payload, and the first synchronization header is used to indicate that a payload following the first synchronization header is a control-type payload, and the termination payload is capable of carrying a remaining code block after the transmit end groups the original data.

The termination payload is capable of carrying a remaining code block after the original data is grouped includes that there may be a remaining code block or no remaining code block after the transmit end groups the original data. When there is a remaining code block after the transmit end groups the original data, the termination payload is used to carry the remaining code block, or when there is no remaining code block after the transmit end groups the original data, the termination payload includes no remaining code block.

In the method for sending interface data provided in the first aspect, because the encoded data sent by the transmit end to the receive end includes the termination code block, when starting to receive the encoded data, the receive end can acquire that the transmission process of the original data starts, and when receiving the termination code block included in the encoded data, the receive end can acquire that the transmission process of the original data terminates. Therefore, according to the method for sending interface data provided in the first aspect, a start and stop location of the original data in the encoded data can be delimited such that after receiving the encoded data, the receive end can accurately restore, according to the start and stop location of the original data, the original data sent by the transmit end.

In the first aspect, when a data length of the original data is relatively short, the encoded data sent by the transmit end to the receive end may include only the termination code block. In a possible design, when the data length of the original data is relatively long, the encoded data sent by the transmit end to the receive end may further include at least one data code block, the at least one data code block precedes the termination code block, and each of the at least one data code block includes a second synchronization header and a data payload, and the second synchronization header is used to indicate that a payload following the second synchronization header is a data-type payload, and the data payload is obtained after the transmit end groups the original data.

According to the foregoing solution, because the encoded data includes the at least one data code block and the termination code block, the receive end can delimit the start and stop location of the original data after receiving the encoded data in order to restore the original data. In addition, because the encoded data includes the at least one data code block, the transmit end can encode the original data with any length when encoding the original data, and the original data restored from the encoded data that is received by the receive end may have any length. That is, according to the foregoing solution, interface data transmission of the original data with any length between the transmit end and the receive end that are in the interface system can be supported.

In the method for sending interface data provided in the first aspect, the receive end may determine, in two manners, that the transmission process of the original data starts. Manner 1: When receiving the encoded data, the receive end learns that the transmission process of the original data starts. Manner 2: A local identifier may be set in the receive end, and when a status of the local identifier changes from a “waiting for a new data packet” state to a “receiving the new data packet” state, the receive end can acquire that the transmission process of the original data starts. In addition, the transmit end may add a start code block to the encoded data, the start code block is used to indicate that the transmission process of the original data starts, the start code block precedes the termination code block, and the start code block includes the first synchronization header, a code block type field indicating that the transmission process starts, and a start payload, and the start payload is capable of carrying a code block reserved before the transmit end groups the original data.

According to the foregoing solution, a manner of acquiring, by the receive end, that the transmission process of the original data starts is provided.

When the transmit end transmits data to the receive end using the method for sending interface data provided in the first aspect, the method may be further applied to the following two scenarios.

Scenario 1: Burst Transmission Scenario.

In a possible design, after encoding the original data, the transmit end may further insert a synchronization mode sequence and a burst delimiter before the encoded data, and insert a burst termination code block after the encoded data to obtain burst transmission data, and the transmit end sends the burst transmission data to the receive end when sending the encoded data to the receive end.

The synchronization mode sequence is used to implement synchronization of the interface system, the burst delimiter is used to indicate that a burst transmission process of the original data starts, and the burst termination code block is used to indicate that the burst transmission process of the original data terminates.

Implementing synchronization of the interface system means implementing synchronization between the receive end in the interface system and the transmit end in the interface system.

According to the foregoing solution, burst transmission between the transmit end and the receive end can be supported. When the transmit end and the receive end perform burst transmission, the receive end may be synchronized with the transmit end according to the synchronization mode sequence in the burst transmission data, thereby ensuring accuracy of the restored original data. The receive end can acquire, using an indication of the burst termination code block in the burst transmission data, that the burst transmission process terminates. When the burst transmission process terminates, data transmission does not need to be performed between a baseband chip and a radio frequency chip that are in a terminal device. In this case, the terminal device may be adjusted to be in a low power consumption mode, thereby reducing power consumption of the terminal device.

In addition, after encoding the original data, the transmit end may perform scrambling process on the encoded data using a preset scrambling code. In this case, after receiving the encoded data, the receive end may perform descrambling process using a corresponding preset descrambling code.

Performing scrambling process on the encoded data by the transmit end can reduce an occurrence probability of a case in which multiple bits 0 or multiple bits 1 consecutively appear in a sequence of the encoded data, facilitating the receive end to identify the encoded data. In this way, signal spectrum of an encoded signal having undergone scrambling process is more suitable for data transmission between the baseband chip and the radio frequency chip. After the transmit end performs scrambling process on the encoded data, the receive end needs to perform descrambling process on the encoded data.

Scenario 2: Control Message Transmission Scenario.

In a possible design, the transmit end may insert a control message into the encoded data, where the control message includes the first synchronization header, a code block type field indicating transmission of the control message, and a control message payload, and when sending the encoded data to the receive end, the transmit end may send, to the receive end, the encoded data into which the control message is inserted.

Because data transmission is mainly performed between a baseband chip and a radio frequency chip that are in a terminal device, in the method for sending interface data provided in the first aspect, a code block that is used to transmit the control message is not reserved in the encoded data sent by the transmit end to the receive end. Therefore, transmission efficiency of interface data can be increased. When the control message needs to be transmitted, according to the foregoing manner of transmitting the control message, a channel with a relatively high priority can be provided for transmitting the control message such that the control message can be accurately transmitted by the transmit end in the interface system to the receive end in the interface system in a timely manner.

In the method for sending interface data provided in the first aspect, a length of the remaining code block may be less than or equal to a length of the termination payload. Optionally, when the length of the remaining code block is less than the length of the termination payload, the termination payload is further used to carry at least one dummy bit sequence. In this case, the code block type field that is in the termination code block and that indicates that the transmission process terminates may be further used to indicate the length of the remaining code block.

When lengths of bit sequences included in the remaining code block are different, code block type fields that are included in the termination code block and that indicate that a transmission process terminates may be different such that the receive end in the interface system determines, from the termination code block according to the code block type fields that are in the termination code block and that indicate that the transmission process terminates, which bit sequences are remaining code blocks and which bit sequences are dummy bit sequences added when the transmit end encodes the original data.

According to a second aspect, an embodiment of this application provides a method for receiving interface data, where the method includes receiving, by a receive end, encoded data sent by a transmit end in an interface system, where the encoded data includes a termination code block, the termination code block is used to indicate that a transmission process of original data corresponding to the encoded data that is sent by the transmit end terminates, and the termination code block includes a first synchronization header, a code block type field indicating that the transmission process terminates, and a termination payload, and the first synchronization header is used to indicate that a payload following the first synchronization header is a control-type payload, and the termination payload is capable of carrying a remaining code block after the transmit end groups the original data when encoding the original data, acquiring, by the receive end by identifying the termination code block included in the encoded data, that the transmission process of the original data terminates, and obtaining the termination payload according to an indication of the code block type field that is included in the termination code block and that indicates that the transmission process terminates, and using the remaining code block carried in the termination payload, as the original data.

The termination payload is capable of carrying a remaining code block after the transmit end groups the original data when encoding the original data includes that there may be a remaining code block or no remaining code block after the transmit end groups the original data. When there is a remaining code block after the transmit end groups the original data, the termination payload is used to carry the remaining code block, or when there is no remaining code block after the transmit end groups the original data, the termination payload includes no remaining code block.

In the method for receiving interface data provided in the second aspect, because the encoded data received by the receive end includes the termination code block, when starting to receive the encoded data, the receive end can acquire that the transmission process of the original data starts, and when receiving the termination code block included in the encoded data, the receive end can acquire that the transmission process of the original data terminates. Therefore, according to the method for receiving interface data provided in the second aspect, the receive end can delimit a start and stop location of the original data in the encoded data such that after receiving the encoded data, the receive end can accurately restore, according to the start and stop location of the original data, the original data sent by the transmit end.

In the second aspect, when a data length of the original data is relatively short, the encoded data received by the receive end may include only the termination code block. In a possible design, when the data length of the original data is relatively long, the encoded data received by the receive end may further include at least one data code block, the at least one data code block precedes the termination code block, and each of the at least one data code block includes a second synchronization header and a data payload, and the second synchronization header is used to indicate that a payload following the second synchronization header is a data-type payload, and the data payload is obtained after the transmit end groups the original data.

In this case, the receive end may further obtain at least one data payload according to an indication of the second synchronization header that is included in each of the at least one data code block, and combine the at least one data payload and the remaining code block to obtain the original data.

According to the foregoing solution, because the encoded data includes the at least one data code block and the termination code block, the receive end can delimit the start and stop location of the original data after receiving the encoded data in order to restore the original data. In addition, because the encoded data includes the at least one data code block, the transmit end can encode the original data with any length when encoding the original data, and the original data restored from the encoded data that is received by the receive end may have any length. That is, according to the foregoing solution, interface data transmission of the original data with any length between the transmit end and the receive end that are in the interface system can be supported.

In the interface data transmission method provided in the second aspect, the receive end may determine, in two manners, that the transmission process of the original data starts. Manner 1: When receiving the encoded data, the receive end can acquire that the transmission process of the original data starts. Manner 2: A local identifier may be set in the receive end, and when a status of the local identifier changes from a “waiting for a new data packet” state to a “receiving the new data packet” state, the receive end can acquire that the transmission process of the original data starts. In addition, the encoded data may include a start code block, the start code block precedes the termination code block, and the start code block includes the first synchronization header, a code block type field indicating that the transmission process starts, and a start payload, and the start payload is capable of carrying a code block reserved before the transmit end groups the original data. After receiving the start code block included in the encoded data, the receive end can acquire that the transmission process of the original data starts, the receive end may obtain, according to an indication of the code block type field that is included in the start code block and that indicates that the transmission process starts, a reserved code block carried in the start payload, and the receive end may combine the reserved code block and the remaining code block to obtain the original data.

In addition, when the encoded data includes the start code block, the at least one data code block, and the termination code block, the receive end needs to combine the reserved code block, the at least one data payload, and the remaining code block that are obtained by means of decoding to obtain the original data.

According to the foregoing solution, a manner of acquiring, by the receive end, that the transmission process of the original data starts is provided.

The method for receiving interface data provided in the second aspect may be further applied to the following two scenarios.

Scenario 1: Burst Transmission Scenario.

In a possible design, receiving, by a receive end, encoded data includes receiving, by the receive end, burst transmission data, where the burst transmission data includes a synchronization mode sequence, a burst delimiter, the encoded data, and a burst termination code block, and the synchronization mode sequence is used to implement synchronization of the interface system, the burst delimiter is used to indicate that a burst transmission process of the original data starts, and the burst termination code block is used to indicate that the burst transmission process of the original data terminates.

Implementing synchronization of the interface system means implementing synchronization between the receive end in the interface system and the transmit end in the interface system.

Before acquiring, by identifying the termination code block, that the transmission process of the original data terminates, the receive end may be synchronized with the transmit end according to the synchronization mode sequence, and acquire, by identifying the burst delimiter, that the burst transmission process of the original data starts, and after obtaining the termination payload by means of decoding, the receive end can acquire, by identifying the burst termination code block, that the burst transmission process of the original data terminates.

According to the foregoing solution, burst transmission between the transmit end and the receive end can be supported. When the transmit end and the receive end perform burst transmission, the receive end may be synchronized with the transmit end according to the synchronization mode sequence in the burst transmission data, thereby ensuring accuracy of the restored original data. The receive end can acquire, using an indication of the burst termination code block in the burst transmission data, that the burst transmission process terminates. When the burst transmission process terminates, data transmission does not need to be performed between a baseband chip and a radio frequency chip that are in a terminal device. In this case, the terminal device may be adjusted to be in a low power consumption mode, thereby reducing power consumption of the terminal device.

In addition, if the transmit end performs scrambling process on the encoded data using a preset scrambling code, after receiving the encoded data, the receive end further needs to perform descrambling process on the encoded data using a preset descrambling code.

Performing scrambling process on the encoded data by the transmit end can reduce an occurrence probability of a case in which multiple bits 0 or multiple bits 1 consecutively appear in a sequence of the encoded data, facilitating the receive end to identify the encoded data. In this way, signal spectrum of an encoded signal having undergone scrambling process is more suitable for data transmission between the baseband chip and the radio frequency chip. After the transmit end performs scrambling process on the encoded data, the receive end needs to perform descrambling process on the encoded data. When performing descrambling process, the receive end makes, according to the burst delimiter, descrambling process be synchronized with scrambling process. This can improve accuracy of the original data obtained by decoding by the receive end.

Scenario 2: Control Message Transmission Scenario.

In a possible design, receiving, by a receive end, encoded data includes receiving, by the receive end, the encoded data into which a control message is inserted, where the control message includes the first synchronization header, a code block type field indicating transmission of the control message, and a control message payload. Therefore, the receive end may obtain the control message payload according to an indication of the code block type field that is included in the control message and that indicates transmission of the control message.

Because data transmission is mainly performed between a baseband chip and a radio frequency chip that are in a terminal device, in the method for receiving interface data provided in the second aspect, a code block that is used to transmit the control message is not reserved in the received encoded data. Therefore, transmission efficiency of interface data can be increased. When the control message needs to be transmitted, according to the foregoing manner of transmitting the control message, a channel with a relatively high priority can be provided for transmitting the control message such that the control message can be accurately transmitted by the transmit end in the interface system to the receive end in the interface system in a timely manner.

In the method for receiving interface data provided in the second aspect, a length of the remaining code block may be less than or equal to a length of the termination payload. Optionally, when the length of the remaining code block is less than the length of the termination payload, the termination payload is further used to carry at least one dummy bit sequence. In this case, the code block type field that is in the termination code block and that indicates that a transmission process terminates may be further used to indicate the length of the remaining code block.

When lengths of bit sequences included in the remaining code block are different, code block type fields that are included in the termination code block and that indicate that a transmission process terminates may be different such that the receive end in the interface system determines, from the termination code block according to the code block type fields that are in the termination code block and that indicate that a transmission process terminates, which bit sequences are remaining code blocks and which bit sequences are dummy bit sequences added when the transmit end encodes the original data.

According to a third aspect, an embodiment of this application provides a data transmission interface, including a processor and a transceiver.

The processor is configured to encode original data to obtain encoded data, where the encoding operation includes grouping the original data.

The transceiver is further configured to send the encoded data to a receive end in an interface system.

The encoded data includes a termination code block, the termination code block is used to indicate that a transmission process of the original data terminates, and the termination code block includes a first synchronization header, a code block type field indicating that the transmission process terminates, and a termination payload, and the first synchronization header is used to indicate that a payload following the first synchronization header is a control-type payload, and the termination payload is capable of carrying a remaining code block after the processor groups the original data.

In the data transmission interface provided in the third aspect, because the encoded data sent by the transceiver to the receive end includes the termination code block, when starting to receive the encoded data, the receive end can acquire that the transmission process of the original data starts, and when receiving the termination code block included in the encoded data, the receive end can acquire that the transmission process of the original data terminates. Therefore, according to the data transmission interface provided in the third aspect, a start and stop location of the original data in the encoded data can be delimited such that after receiving the encoded data, the receive end can accurately restore, according to the start and stop location of the original data, the original data sent by a transmit end.

In the third aspect, when a data length of the original data is relatively short, the encoded data sent by the transceiver to the receive end may include only the termination code block. In a possible design, when the data length of the original data is relatively long, the encoded data sent by the transceiver to the receive end may further include at least one data code block, the at least one data code block precedes the termination code block, and each of the at least one data code block includes a second synchronization header and a data payload, and the second synchronization header is used to indicate that a payload following the second synchronization header is a data-type payload, and the data payload is obtained after the processor groups the original data.

According to the foregoing solution, because the encoded data sent by the transceiver to the receive end includes the at least one data code block and the termination code block, the receive end can delimit the start and stop location of the original data after receiving the encoded data in order to restore the original data. In addition, because the encoded data includes the at least one data code block, the processor can encode the original data with any length when encoding the original data, and the original data restored from the encoded data that is received by the receive end may have any length. That is, according to the foregoing solution, interface data transmission of the original data with any length between the transmit end and the receive end that are in the interface system can be supported.

In the data transmission interface provided in the third aspect, the receive end may determine, in two manners, that the transmission process of the original data starts. Manner 1: When receiving the encoded data, the receive end acquires that the transmission process of the original data starts. Manner 2: A local identifier may be set in the receive end, and when a status of the local identifier changes from a “waiting for a new data packet” state to a “receiving the new data packet” state, the receive end can acquire that the transmission process of the original data starts. In addition, the processor may add a start code block to the encoded data, and the start code block is used to indicate that the transmission process of the original data starts. When receiving the start code block, the receive end can acquire that the transmission process of the original data starts. The start code block includes the first synchronization header, a code block type field indicating that the transmission process starts, and a start payload, and the start payload is capable of carrying a code block reserved before the processor groups the original data.

According to the foregoing solution, a manner of acquiring, by the receive end, that the transmission process of the original data starts is provided.

The data transmission interface provided in the third aspect may be further applied to the following two scenarios.

Scenario 1: Burst Transmission Scenario.

In a possible design, after encoding the original data, the processor is further configured to insert a synchronization mode sequence and a burst delimiter before the encoded data, and insert a burst termination code block after the encoded data, to obtain burst transmission data, and the transceiver sends the burst transmission data to the receive end when sending the encoded data to the receive end. The synchronization mode sequence is used to implement synchronization of the interface system, the burst delimiter is used to indicate that a burst transmission process of the original data starts, and the burst termination code block is used to indicate that the burst transmission process of the original data terminates.

According to the foregoing solution, burst transmission between the transmit end and the receive end can be supported. The receive end may be synchronized with the transmit end according to the synchronization mode sequence in the burst transmission data, thereby ensuring accuracy of the restored original data. The receive end can acquire, using an indication of the burst termination code block in the burst transmission data, that the burst transmission process terminates. When the burst transmission process terminates, data transmission does not need to be performed between a baseband chip and a radio frequency chip that are in a terminal device. In this case, the terminal device may be adjusted to be in a low power consumption mode, thereby reducing power consumption of the terminal device.

In addition, the processor may perform scrambling process on the encoded data using a preset scrambling code. In this case, after receiving the encoded data, the receive end needs to perform descrambling process on the encoded data using a preset descrambling code.

Performing scrambling process on the encoded data by the processor can reduce an occurrence probability of a case in which multiple bits 0 or multiple bits 1 consecutively appear in a sequence of the encoded data, facilitating the receive end to identify the encoded data. In this way, signal spectrum of an encoded signal having undergone scrambling process is more suitable for data transmission between the baseband chip and the radio frequency chip.

Scenario 2: Control Message Transmission Scenario

In a possible design, the processor is further configured to insert a control message into the encoded data, where the control message includes the first synchronization header, a code block type field indicating transmission of the control message, and a control message payload, and when sending the encoded data to the receive end, the transceiver may send, to the receive end, the encoded data into which the control message is inserted.

Because data transmission is mainly performed between a baseband chip and a radio frequency chip that are in a terminal device, a code block that is used to transmit the control message is not reserved in the encoded data sent by the transceiver to the receive end. Therefore, transmission efficiency of interface data can be increased. When the control message needs to be transmitted, according to the foregoing manner of transmitting the control message, a channel with a relatively high priority can be provided for transmitting the control message such that the control message can be accurately transmitted by the transmit end to the receive end in a timely manner.

In the data transmission interface provided in the third aspect, a length of the remaining code block may be less than or equal to a length of the termination payload. Optionally, when the length of the remaining code block is less than the length of the termination payload, the termination payload is further used to carry at least one dummy bit sequence. In this case, the code block type field in the termination code block indicating that the transmission process terminates may be further used to indicate the length of the remaining code block.

When lengths of bit sequences included in the remaining code block are different, code block type fields included in the termination code block indicating that a transmission process terminates may be different such that the receive end in the interface system determines, from the termination code block according to the code block type fields in the termination code block indicating that the transmission process terminates, which bit sequences are remaining code blocks and which bit sequences are dummy bit sequences added when the transmit end encodes the original data.

According to a fourth aspect, an embodiment of this application provides a data transmission interface, where the data transmission interface includes a transceiver and a processor.

The transceiver is configured to receive encoded data sent by a transmit end in an interface system.

The encoded data includes a termination code block, the termination code block is used to indicate that a transmission process of original data corresponding to the encoded data that is sent by the transmit end terminates, and the termination code block includes a first synchronization header, a code block type field indicating that the transmission process terminates, and a termination payload, and the first synchronization header is used to indicate that a payload following the first synchronization header is a control-type payload, and the termination payload is capable of carrying a remaining code block after the transmit end groups the original data when encoding the original data.

The processor is configured to acquire, by identifying the termination code block included in the encoded data, that the transmission process of the original data terminates, and obtain, by means of decoding and according to an indication of the code block type field that is included in the termination code block and that indicates that the transmission process terminates, the remaining code block carried in the termination payload, as the original data.

In the data transmission interface provided in the fourth aspect, because the encoded data received by the transceiver includes the termination code block, when the transceiver starts to receive the encoded data, the processor can acquire that the transmission process of the original data starts, and the processor can acquire that the transmission process of the original data terminates when the transceiver starts to receive the termination code block included in the encoded data. Therefore, according to the data transmission interface provided in the fourth aspect, the processor can delimit a start and stop location of the original data in the encoded data such that after the transceiver receives the encoded data, the processor can accurately restore, according to the start and stop location of the original data, the original data sent by the transmit end.

In the fourth aspect, when a data length of the original data is relatively short, the encoded data received by the transceiver may include only the termination code block. In a possible design, when the data length of the original data is relatively long, the encoded data received by the transceiver may further include at least one data code block, the at least one data code block precedes the termination code block, and each of the at least one data code block includes a second synchronization header and a data payload, and the second synchronization header is used to indicate that a payload following the second synchronization header is a data-type payload, and the data payload is obtained after the transmit end groups the original data.

In this case, the processor may be further configured to obtain at least one data payload according to an indication of the second synchronization header that is included in each of the at least one data code block, and the processor may combine the at least one data payload and the remaining code block to obtain the original data when using the remaining code block as the original data.

According to the foregoing solution, because the encoded data includes the at least one data code block and the termination code block, the processor can delimit the start and stop location of the original data after the transceiver receives the encoded data in order to restore the original data. In addition, because the encoded data includes the at least one data code block, the transmit end can encode the original data with any length when encoding the original data, and the original data restored by the processor according to the encoded data received by the transceiver may have any length. That is, according to the foregoing solution, transmission of the original data with any length can be supported.

In the data transmission interface provided in the fourth aspect, the processor may determine, in two manners, that the transmission process of the original data starts. Manner 1: When the transceiver receives the encoded data, the processor can acquire that the transmission process of the original data starts. Manner 2: The processor may set a local identifier, and when a status of the local identifier changes from a “waiting for a new data packet” state to a “receiving the new data packet” state, the processor acquires that the transmission process of the original data starts. In addition, the encoded data may include a start code block, the start code block precedes the termination code block, and the start code block includes the first synchronization header, a code block type field indicating that the transmission process starts, and a start payload, and the start payload is capable of carrying a code block reserved before the transmit end groups the original data. In this case, after the transceiver receives the encoded data, the processor may further acquire, by identifying the start code block included in the encoded data, that the transmission process of the original data starts, and obtain, by means of decoding and according to an indication of the code block type field that is included in the start code block and that indicates that the transmission process starts, a reserved code block carried in the start payload. Then, the processor combines the reserved code block and the remaining code block to obtain the original data.

In addition, when the encoded data includes the start code block, the at least one data code block, and the termination code block, the processor needs to combine the reserved code block, the at least one data payload, and the remaining code block that are obtained by means of decoding, to obtain the original data.

According to the foregoing solution, a manner of acquiring, by the receive end, that the transmission process of the original data starts is provided.

The data transmission interface provided in the fourth aspect may be further applied to the following two scenarios.

Scenario 1: Burst Transmission Scenario.

In a possible design, when receiving the encoded data, the transceiver may receive burst transmission data, where the burst transmission data includes a synchronization mode sequence, a burst delimiter, the encoded data, and a burst termination code block, and the synchronization mode sequence is used to implement synchronization of the interface system, the burst delimiter is used to indicate that a burst transmission process of the original data starts, and the burst termination code block is used to indicate that the burst transmission process of the original data terminates.

In this case, before acquiring, by identifying the termination code block, that the transmission process of the original data terminates, the processor may be synchronized with the transmit end according to the synchronization mode sequence, and acquire, by identifying the burst delimiter, that the burst transmission process of the original data starts, and after obtaining the termination payload by means of decoding, the processor can acquire, by identifying the burst termination code block, that the burst transmission process of the original data terminates.

According to the foregoing solution, the processor may be synchronized with the transmit end according to the synchronization mode sequence in the burst transmission data, thereby ensuring accuracy of the original data restored by the processor. The processor can acquire, using an indication of the burst termination code block in the burst transmission data, that the burst transmission process terminates. When the burst transmission process terminates, data transmission does not need to be performed between a baseband chip and a radio frequency chip that are in a terminal device. In this case, the terminal device may be adjusted to be in a low power consumption mode, thereby reducing power consumption of the terminal device.

In addition, if the transmit end performs scrambling process on the encoded data using a preset scrambling code, the processor needs to perform, using a corresponding preset descrambling code, descrambling process on the encoded data received by the transceiver.

Performing scrambling process on the encoded data by the transmit end can reduce an occurrence probability of a case in which multiple bits 0 or multiple bits 1 consecutively appear in a sequence of the encoded data, facilitating the processor to identify the encoded data. In this way, signal spectrum of an encoded signal having undergone scrambling process is more suitable for data transmission between the baseband chip and the radio frequency chip.

Scenario 2: Control Message Transmission Scenario.

In a possible design, when receiving the encoded data, the transceiver may receive the encoded data into which a control message is inserted, where the control message includes the first synchronization header, a code block type field indicating transmission of the control message, and a control message payload, and the processor may obtain, by means of decoding, the control message payload according to an indication of the code block type field that is in the control message and that indicates transmission of the control message.

Because data transmission is mainly performed between a baseband chip and a radio frequency chip that are in a terminal device, a code block that is used to transmit the control message is not reserved in the encoded data received by the transceiver. Therefore, transmission efficiency of interface data can be increased. When the control message needs to be transmitted, according to the foregoing manner of transmitting the control message, a channel with a relatively high priority can be provided for transmitting the control message such that the control message can be accurately transmitted by the transmit end to the receive end in a timely manner.

In the data transmission interface provided in the fourth aspect, a length of the remaining code block may be less than or equal to a length of the termination payload. Optionally, when the length of the remaining code block is less than the length of the termination payload, the termination payload is further used to carry at least one dummy bit sequence. In this case, the code block type field that is in the termination code block and that indicates that the transmission process terminates may be further used to indicate the length of the remaining code block.

When lengths of bit sequences included in the remaining code block are different, code block type fields that are included in the termination code block and that indicate that a transmission process terminates may be different such that the processor determines, from the termination code block according to the code block type fields that are in the termination code block and that indicate that the transmission process terminates, which bit sequences are remaining code blocks and which bit sequences are dummy bit sequences added when the transmit end encodes the original data.

According to a fifth aspect, an embodiment of the present disclosure provides an interface system, where the interface system includes the data transmission interface provided in the third aspect or any possible design of the third aspect and the data transmission interface provided in the fourth aspect or any possible design of the fourth aspect.

### BRIEF DESCRIPTION OF DRAWINGS

FIG. 1 is a schematic structural diagram of a terminal device according to an embodiment of this application;

FIG. 2 is a schematic flowchart of an interface data transmission method according to an embodiment of this application;

FIG. 3 is a schematic diagram of a data format of burst transmission data according to an embodiment of this application;

FIG. 4 is a schematic structural diagram of a data transmission interface according to an embodiment of this application;

FIG. 5 is a schematic structural diagram of another data transmission interface according to an embodiment of this application; and

FIG. 6 is a schematic structural diagram of an interface system according to an embodiment of this application.

### DESCRIPTION OF EMBODIMENTS

To make the objectives, technical solutions, and advantages of the embodiments of this application more understandable, the following provides detailed descriptions. The detailed descriptions provide various implementations of an apparatus and/or a method using block diagrams, flowcharts, other accompany drawings, and/or examples. These block diagrams, flowcharts, and/or examples include one or more functions and/or operations. A person skilled in the art understands that each function and/or operation in the block diagrams, the flowcharts, and/or the examples can be performed independently and/or jointly using various hardware, software, and firmware, and/or any combination thereof.

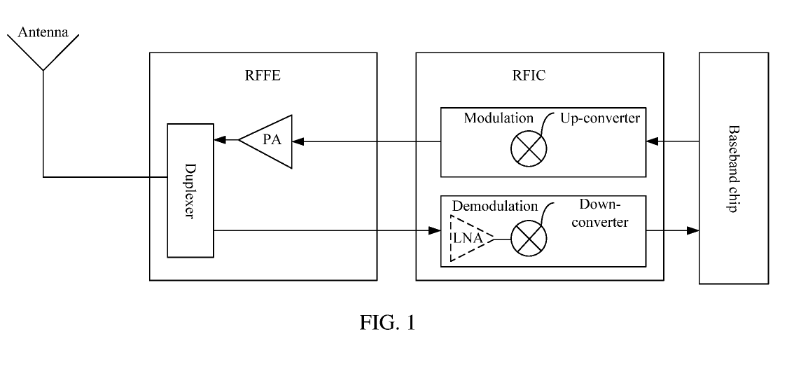

When interface data transmission is performed between a baseband chip and a radio frequency chip that are in a terminal device, an interface data transmission method provided in the embodiments of this application may be used. A basic structure of the terminal device may be shown in FIG. 1.

When the terminal device shown in FIG. 1 performs uplink data transmission, a baseband signal that is output by the baseband chip is modulated by an up-converter in the radio frequency chip (such as Radio Frequency Integrated Circuit (RFIC)), and the baseband signal of a low frequency is frequency-mixed with a local-frequency signal to generate a radio frequency signal of a high frequency (that is, up-conversion), and the radio frequency signal is amplified by a power amplifier (PA) in a radio frequency front end (RFFE), and the amplified radio frequency signal is transmitted using an antenna after a duplexer in the RFFE is coupled to the antenna.

When the terminal device shown in FIG. 1 performs downlink data transmission, a received signal is transmitted to the RFIC using the duplexer in the RFFE, the received signal is demodulated by a down-converter in the RFIC, the received signal of a high frequency is frequency-mixed with a local-frequency signal to generate a baseband signal of a low frequency, and the baseband signal is sent to the baseband chip. In addition, before the received signal is demodulated, the received signal is amplified by a low noise amplifier (LNA) in the RFIC.

In an embodiment of this application, the terminal device includes but is not limited to a smartphone, a smartwatch, a tablet computer, a virtual reality (VR) device, an augmented reality (AR) device, a personal computer, a handheld computer, a personal digital assistant.

In the terminal device shown in FIG. 1, regardless of uplink data transmission or downlink data transmission, a transmit end needs to encode data, and then sends encoded data. The transmit end adds some control code blocks to original data in the encoding process. Therefore, a receive end can accurately restore the original data from the encoded data after delimiting a start and stop location of the original data in the encoded data.

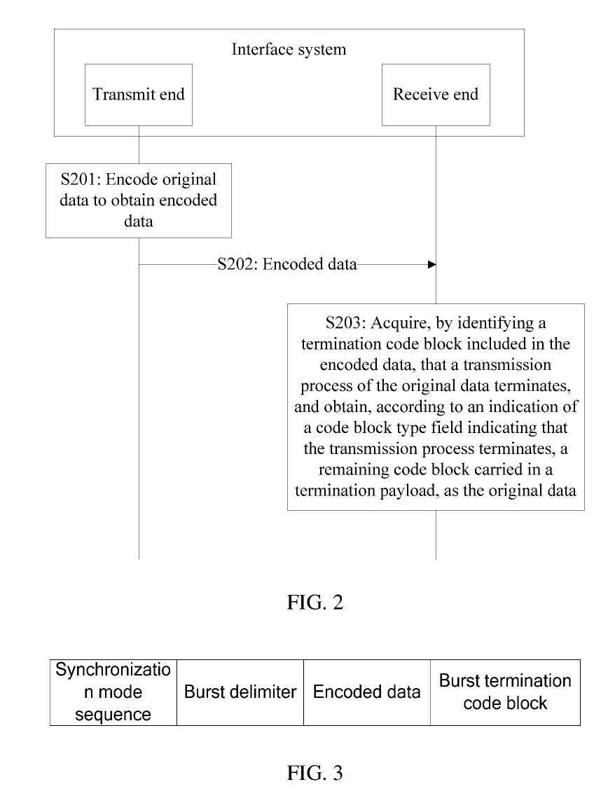

An embodiment of this application provides an interface data transmission method. As shown in FIG. 2, the method includes the following steps.

Step S201: A transmit end in an interface system encodes original data to obtain encoded data.

It should be noted that, the interface data transmission method provided in this embodiment of this application is applied to a scenario in which interface data transmission is performed between a baseband chip and a radio frequency chip that are in a terminal device. Therefore, the transmit end in this embodiment of this application may be the radio frequency chip or the baseband chip, and a receive end may be the baseband chip or the radio frequency chip. That is, when the baseband chip transmits data to the radio frequency chip, the baseband chip is the transmit end, and the radio frequency chip is the receive end, or when the radio frequency chip transmits data to the baseband chip, the radio frequency chip is the transmit end, and the baseband chip is the receive end.

The encoding operation of the transmit end includes grouping the original data. The encoded data includes a termination code block, the termination code block is used to indicate that a transmission process of the original data terminates, and the termination code block includes a first synchronization header, a code block type field indicating that the transmission process terminates, and a termination payload. The first synchronization header is used to indicate that a payload following the first synchronization header is a control-type payload, and the termination payload is capable of carrying a remaining code block after the original data is grouped.

The termination payload is capable of carrying a remaining code block after the original data is grouped includes that there may be a remaining code block or no remaining code block after the transmit end groups the original data. When there is a remaining code block after the transmit end groups the original data, the termination payload is used to carry the remaining code block, or when there is no remaining code block after the transmit end groups the original data, the termination payload includes no remaining code block.

In this embodiment of this application, a length of the remaining code block may be less than or equal to a length of the termination payload. Optionally, when the length of the remaining code block is less than the length of the termination payload, the termination payload is further used to carry at least one dummy bit sequence. In this case, the code block type field that is in the termination code block and that indicates that the transmission process terminates may be further used to indicate the length of the remaining code block.

When lengths of bit sequences included in the remaining code block are different, code block type fields that are included in the termination code block and that indicate that a transmission process terminates may be different such that the receive end in the interface system determines, from the termination code block according to the code block type fields that are in the termination code block and that indicate that the transmission process terminates, which bit sequences are remaining code blocks and which bit sequences are dummy bit sequences added when the transmit end encodes the original data.

Optionally, the encoded data may further include at least one data code block, the at least one code block precedes the termination code block, and each of the at least one data code block includes a second synchronization header and a data payload, and the second synchronization header is used to indicate that a payload following the second synchronization header is a data-type payload, and the data payload is obtained after the transmit end groups the original data.

The second synchronization header may be a sequence that includes bit values obtained by means of bit negation on the first synchronization header and that has a same quantity of bits as the first synchronization header. For the first synchronization header and the second synchronization header, when one of the synchronization headers includes bit values obtained by means of bit negation on the other synchronization header, it is easier for the receive end to distinguish indications of the first synchronization header and the second synchronization header after receiving the encoded data.

Step S202: The transmit end sends the encoded data to a receive end in the interface system.

Step S203: The receive end acquires, by identifying a termination code block included in the encoded data, that a transmission process of the original data terminates, and obtains, according to an indication of a code block type field that is included in the termination code block and indicating the transmission process terminates, a remaining code block carried in a termination payload, as the original data.

When the encoded data includes the at least one data code block and the termination code block, and when executing step S203, the receive end further needs to obtain at least one data payload according to an indication of the second synchronization header that is included in each of the at least one data code block, and obtain the original data after combining the at least one data payload and the remaining code block.

It should be noted that, according to the interface data transmission method provided in this embodiment of this application, the receive end needs to acquire, according to the termination code block, that the transmission process of the original data terminates, and further needs to acquire, in a manner, that the transmission process of the original data starts. A manner of determining that the transmission process of the original data starts includes but is not limited to the following three manners.

Manner 1: When receiving the encoded data, the receive end can acquire that the transmission process of the original data starts.

Manner 2: A local identifier may be set in the receive end, and when a status of the local identifier changes from a “waiting for a new data packet” state to a “receiving the new data packet” state, the receive end can acquire that the transmission process of the original data starts.

Manner 3: The encoded data sent by the transmit end to the receive end may further include a start code block, the start code block precedes the termination code block, and the start code block is used to indicate that the transmission process of the original data starts. When receiving the start code block, the receive end can acquire that the transmission process of the original data starts.

The start code block includes the first synchronization header, a code block type field indicating that the transmission process starts, and a start payload, and the start payload is capable of carrying a code block reserved before the transmit end groups the original data.

For example, when the original data is a sequence including 192 bits, the transmit end may reserve a 56-bit sequence as the start payload before grouping the original data, then, perform grouping on the original data using every 64 bits as one group to obtain two data payloads, and finally, place a remaining 8-bit sequence used as the remaining code block into the termination payload.

When the encoded data includes the start code block, after receiving the encoded data sent by the transmit end, the receive end can acquire, by identifying the start code block, that the transmission process of the original data starts, and obtain, according to an indication of the code block type field that is included in the start code block and that indicates that the transmission process starts, a reserved code block carried in the start payload. In this case, when executing step S203, the receive end needs to combine the reserved code block and the remaining code block to obtain the original data.

It may be acquired with reference to a composition of the encoded data described above that, in the interface data transmission method provided in this embodiment of this application, before performing encoding, the transmit end needs to group the original data, for example, group the original data using every 64 bits (that is, an octet) as one group. A status of grouping the original data by the transmit end determines the composition of the encoded data. The composition of the encoded data includes but is not limited to the following four cases.

Case 1: If the transmit end reserves no reserved code block before grouping the original data, and because a data length of the original data is relatively short, the at least one data payload is not obtained after the original data is grouped, the original data is carried in the termination code block, that is, the encoded data includes the termination code block.

For example, when the transmit end groups the original data using every 64 bits as one group, if the original data is a sequence including n bits, where n<64, when the transmit end groups the to-be-sent original data using every 64 bits as one group, because n<64, an n-bit sequence remains after grouping is performed. The remaining n-bit sequence may be placed into the remaining code block, and the termination code block may be formed after the first synchronization header and the code block type field indicating that the transmission process terminates are added before the remaining code block. The encoded data includes the termination code block.

Case 2: If the transmit end reserves the reserved code block before grouping the original data, the at least one data payload is not obtained after the original data is grouped, and there is the remaining code block after the original data is grouped, the encoded data includes the start code block and the termination code block.

For example, if the original data is a sequence including n bits, and the transmit end reserves a 56-bit sequence as the reserved code block before grouping the original data, the start code block may be formed after the first synchronization header and the code block type field indicating that the transmission process starts are added before the reserved code block. When the transmit end groups, using every 64 bits as one group, a sequence including the remaining (n−56) bits, if n−56<64, the data payload cannot be obtained when the transmit end performs grouping, and an (n−56)-bit sequence remains after grouping is performed. The (n−56)-bit sequence may be placed into the remaining code block, and the termination code block may be formed after the first synchronization header and the code block type field indicating that the transmission process terminates are added before the remaining code block. The encoded data includes the start code block and the termination code block.

Case 3: If the transmit end reserves no reserved code block before grouping the original data, the at least one data payload is obtained after the original data is grouped, and there is the remaining code block after the original data is grouped, the encoded data includes the at least one data code block and the termination code block.

For example, the original data is a sequence including 152 bits. When the transmit end groups the to-be-sent original data using every 64 bits as one group, two 64-bit sequences and a remaining 24-bit sequence can be obtained. In this case, each of the two 64-bit sequences obtained after grouping is performed may be used as a data payload in a data code block, the remaining 24-bit sequence may be placed into the termination code block, two data code blocks may be formed after the second synchronization header is added before each 64-bit sequence, and the termination code block may be formed after the first synchronization header and the code block type field indicating that the transmission process terminates are added before the remaining 24-bit sequence. The encoded data includes the two data code blocks and the termination code block.

Case 4: If the transmit end reserves the reserved code block before grouping the original data, the at least one data payload is obtained after the original data is grouped, and there is the remaining code block after the original data is grouped, the encoded data includes the start code block, the at least one data code block, and the termination code block.

For example, if the original data is a sequence including n bits, and the transmit end reserves a 56-bit sequence as the reserved code block before grouping the original data, the start code block may be formed after the first synchronization header and the code block type field indicating that the transmission process starts are added before the reserved code block. When the transmit end groups, using every 64 bits as one group, a sequence including the remaining (n−56) bits, if n−56>64, the at least one data payload is obtained when the transmit end performs grouping, and there is the remaining code block after grouping is performed. In this case, the at least one data code block may be formed after the second synchronization header is added before the at least one data payload, and the termination code block may be formed after the first synchronization header and the code block type field indicating that the transmission process terminates are added before the remaining code block. The encoded data includes the start code block, the at least one data code block, and the termination code block.

In addition, in this embodiment of this application, because the payload following the first synchronization header is the control-type payload to distinguish different control-type payloads, a code block type field needs to be added after the first synchronization header. The code block type field is used to indicate a type of a control-type payload following the code block type field. For example, both the start payload and the termination payload are control-type payloads. When encoding the original data, the transmit end may add a code block type field A after the first synchronization header included in the start code block and before the start payload included in the start code block, and add a code block type field B after the first synchronization header included in the termination code block and before the termination payload included in the termination code block. The code block type field A is used to indicate that a payload following the code block type field A is the start payload, and the code block type field B is used to indicate that a payload following the code block type field B is the termination payload. Particularly, the code block type field A included in the start code block may be referred to as a start delimiter, and the code block type field B included in the termination code block may be referred as a termination delimiter. In addition, for ease of description, in this embodiment of this application, a code block including the first synchronization header, a code block type field, and a control-type payload is referred to as a control code block.

In this embodiment of this application, a quantity of bits included in the start payload may be the same as a quantity of bits included in the data payload, and a quantity of bits included in the termination payload may be the same as the quantity of bits included in the data payload. Because the start payload is the code block reserved before the transmit end groups the original data, the quantity of bits included in the start payload is less than the quantity of bits included in the data payload, and because the termination payload is the remaining code block after the transmit end groups the original data, the quantity of bits included in the termination payload is less than the quantity of bits included in the data payload. When the quantity of bits included in the start payload is less than the quantity of bits included in the data payload, several dummy bit sequences are added after the reserved code block such that the quantity of bits included in the start payload is the same as the quantity of bits included in the data payload, and when the quantity of bits included in the termination payload is less than the quantity of bits included in the data payload, several dummy bit sequences are added after the remaining code block such that the quantity of bits included in the termination payload is the same as the quantity of bits included in the data payload.

For example, if the original data is a sequence including 192 bits, the code block type field indicating that the transmission process starts and the code block type field indicating that the transmission process terminates are included in the start code block and the termination code block, respectively, and each of the code block type field indicating that the transmission process starts and the code block type field indicating that the transmission process terminates is a sequence including eight bits. The transmit end reserves a 56-bit sequence as the reserved code block before grouping the original data, and the transmit end performs grouping on the original data using every 64 bits as one group to obtain two data payloads, and places a remaining 8-bit sequence as the remaining code block into the termination payload. A quantity of bits included in the data payload is 64, and the start payload includes the code block type field indicating that the transmission process starts and the reserved code block, that is, the quantity of bits included in the start payload is also 64. Therefore, to allow the quantity of bits included in the termination payload to be also 64, a 48-bit dummy bit sequence needs to be added after the remaining code block such that a quantity of bits included in the termination payload that includes the code block type field indicating that the transmission process terminates, the remaining code block, and the dummy bit sequence is also 64.

It should be noted that, when the encoded data includes the at least one data code block and the termination code block, a quantity of termination payloads included in the termination code block may be zero according to the status of grouping the original data by the transmit end. For example, when the original data is a sequence including 128 bits, if the transmit end groups the original data using every 64 bits as one group, the transmit end obtains two data payloads by means of grouping, and there is no remaining code block. In this case, the transmit end needs to fill the termination payload with several dummy bit sequences such that the quantity of bits included in the termination payload is the same as a quantity of bits included in the data payload.

According to the interface data transmission method provided in this embodiment of the present disclosure, because the encoded data sent by the transmit end to the receive end includes the termination code block, when starting to receive the encoded data, the receive end can acquire that the transmission process of the original data starts, and when receiving the termination code block included in the encoded data, the receive end can acquire that the transmission process of the original data terminates. Therefore, according to the interface data transmission method provided in this embodiment of this application, a start and stop location of the original data in the encoded data can be delimited such that after receiving the encoded data, the receive end can accurately restore, according to the start and stop location of the original data, the original data sent by the transmit end.

In addition, in this embodiment of this application, when the data length of the original data is relatively short, the encoded data sent by the transmit end to the receive end may include only the termination code block, or when the data length of the original data is relatively long, the encoded data sent by the transmit end to the receive end may include the at least data code block and the termination code block. Therefore, the interface data transmission method provided in this embodiment of this application is applicable to transmission of data with any length between the baseband chip and the radio frequency chip, and has a wide scope of application.

The interface data transmission method provided in this embodiment of this application may also be used when the transmit end and the receive end perform burst transmission. When the transmit end and the receive end need to perform burst transmission, the transmit end inserts a synchronization mode sequence and a burst delimiter before the encoded data, and inserts a burst termination code block after the encoded data, to obtain burst transmission data. When executing step S202, the transmit end may send the burst transmission data to the receive end. The synchronization mode sequence is used to implement synchronization of the interface system, the burst delimiter is used to indicate that a burst transmission process of the original data starts, and the burst termination code block is used to indicate that the burst transmission process of the original data terminates.

Implementing synchronization of the interface system means implementing synchronization between the receive end in the interface system and the transmit end in the interface system. The synchronization mode sequence may include multiple same specified sequences. After receiving the synchronization sequence, the receive end may be synchronized with the transmit end using the multiple same specified sequences. When receiving the burst delimiter, the receive end can acquire that the burst transmission process starts. Then, the receive end can accurately restore the original data from the encoded data following the burst delimiter. When receiving the burst termination code block, the receive end can acquire that the burst transmission process terminates.

In this embodiment of this application, a data format of the burst transmission data may be shown in FIG. 3. In FIG. 3, the burst transmission data sequentially includes the synchronization mode sequence, the burst delimiter, the encoded data, and the burst termination code block. When the transmit end and the receive end perform burst transmission, the receive end may be synchronized with the transmit end according to the synchronization mode sequence in the burst transmission data, thereby improving accuracy of the restored original data. The receive end can acquire, using an indication of the burst termination code block in the burst transmission data, that the burst transmission process terminates. When the burst transmission process terminates, data transmission does not need to be performed between the baseband chip and the radio frequency chip that are in the terminal device. In this case, the terminal device may be adjusted to be in a low power consumption mode, thereby reducing power consumption of the terminal device.

Optionally, after the transmit end and the receive end perform burst transmission, to continue keeping synchronization between the receive end and the transmit end, the transmit end may repeatedly send an idle code block to the receive end. Because the receive end repeatedly receives the idle code block, the receive end may be kept synchronized with the transmit end, but the receive end does not process the received idle code block. Therefore, power consumption of the terminal device can also be reduced in this case.

In addition, after encoding the original data, the transmit end may perform scrambling process on the encoded data using a preset scrambling code, and after receiving the encoded data having undergone scrambling process, the receive end may perform descrambling process on the encoded data using a preset descrambling code.

Performing scrambling process on the encoded data by the transmit end can reduce an occurrence probability of a case in which multiple bits 0 or multiple bits 1 consecutively appear in a sequence of the encoded data, facilitating the receive end to identify the encoded data. In this way, signal spectrum of the encoded data having undergone scrambling process is more suitable for data transmission between the baseband chip and the radio frequency chip that are in the terminal device.

When the interface data transmission method provided in this embodiment of this application is used, if a control message needs to be transmitted to the receive end during transmission of the encoded data, the following manner may be used for implementation. The transmit end inserts the control message into the encoded data, and sends, to the receive end, the encoded data into which the control message is inserted. The control message includes the first synchronization header, a code block type field indicating transmission of the control message, and a control message payload. In this case, when receiving the encoded data into which the control message is inserted, the receive end may obtain the control message payload according to an indication of the code block type field indicating transmission of the control message.

In the manner of sending the control message, the inserting the control message into the encoded data means If the transmit end needs to transmit the control message to the receive end during encoded data transmission between the transmit end and the receive end, the transmit end may temporarily stop sending the encoded data, and then, the transmit end sends the control message, and continues sending the encoded data after completing sending of the control message.

Because data transmission is mainly performed between the baseband chip and the radio frequency chip that are in the terminal device, in the interface data transmission method provided in this embodiment of this application, a code block that is used to transmit the control message is not reserved in the encoded data sent by the transmit end to the receive end. Therefore, transmission efficiency of interface data can be increased. When the control message needs to be transmitted, according to the foregoing manner of transmitting the control message, a channel with a relatively high priority can be provided for transmitting the control message such that the control message can be accurately transmitted by the transmit end to the receive end in a timely manner.

The following describes, using examples, a data structure of the encoded data sent by the transmit end to the receive end in this embodiment of this application. In an example, quantities of bits included in the start payload, the termination payload, and the data payload each are 64, and quantities of bits included in the first synchronization header and the second synchronization header each are 2.

### EXAMPLE 1: A first data structure of the encoded data in this embodiment of this application is listed in Table 1.

TABLE 1
First data structure of the encoded data

| | Synchronization | | | | | | | | |
|---|---|---|---|---|---|---|---|---|---|
| | header | Data payload | | | | | | | |
| Data code | 01 | Dn | Dn + 1 | Dn + 2 | Dn + 3 | Dn + 4 | Dn + 5 | Dn + 6 | Dn + 7 |
| block | | | | | | | | | |

| | Synchronization | Code block | | | | | | | |
|---|---|---|---|---|---|---|---|---|---|
| | header | type field | Control-type payload | | | | | | |
| Termination | 10 | 0x87 | P | P | P | P | P | P | P |
| code block 0 | | | | | | | | | |
| Termination | 10 | 0x99 | Dm | P | P | P | P | P | P |
| code block 1 | | | | | | | | | |
| Termination | 10 | 0xaa | Dm | Dm + 1 | P | P | P | P | P |
| code block 2 | | | | | | | | | |
| Termination | 10 | 0xb4 | Dm | Dm + 1 | Dm + 2 | P | P | P | P |
| code block 3 | | | | | | | | | |
| Termination | 10 | 0xcc | Dm | Dm + 1 | Dm + 2 | Dm + 3 | P | P | P |
| code block 4 | | | | | | | | | |
| Termination | 10 | 0xd2 | Dm | Dm + 1 | Dm + 2 | Dm + 3 | Dm + 4 | P | P |
| code block 5 | | | | | | | | | |
| Termination | 10 | 0xe1 | Dm | Dm + 1 | Dm + 2 | Dm + 3 | Dm + 4 | Dm + 5 | P |
| code block 6 | | | | | | | | | |
| Termination | 10 | 0xff | Dm | Dm + 1 | Dm + 2 | Dm + 3 | Dm + 4 | Dm + 5 | Dm + 6 |
| code block 7 | | | | | | | | | |
| Burst | 10 | 0x55 | 0x55 | 0x55 | 0x55 | 0x55 | 0x55 | 0x55 | 0x55 |
| termination | | | | | | | | | |
| code block | | | | | | | | | |
| Control message | 10 | 0x66 | 0x66 | UDF | UDF | UDF | UDF | UDF | UDF |
| Synchronization | 10 | 0xbf | 0x40 | 0x18 | 0xe5 | 0xc5 | 0x49 | 0xbb | 0x59 |
| mode sequence | | | | | | | | | |
| Burst delimiter | 10 | 0x6b | 0xf8 | 0xd8 | 0x12 | 0xd8 | 0x58 | 0xe4 | 0xab |
| Idle code | 10 | 0x2d | 0 | 0 | 0 | 0 | 0 | 0 | 0 |
| block | | | | | | | | | |

The data structure of the encoded data listed in Table 1 includes two parts. One part is the data code block, and the other part is a control code block that includes a synchronization header, a code block type field, and different control-type payloads. D is obtained after the transmit end groups the original data, Ds placed into different code blocks are identified using different subscripts, and P is a sequence including eight dummy bits.

A synchronization header of the control code block is 10, and 10 may be considered as the first synchronization header in the method shown in FIG. 2, and a synchronization header of the data code block is 01, and 01 may be considered as the second synchronization header in the method shown in FIG. 2.

If the data structure of the encoded data sent by the transmit end to the receive end is listed in Table 1, the encoded data includes one termination code block in Table 1, or includes several data code blocks and one termination code block in Table 1. If the transmit end and the receive end perform burst transmission, the transmit end needs to insert the synchronization mode sequence and the burst delimiter before the encoded data, and insert the burst termination code block after the encoded data.

Optionally, after the transmit end and the receive end perform burst transmission, to continue keeping synchronization between the receive end and the transmit end, the transmit end may repeatedly send the idle code block in Table 1 to the receive end in order to reduce power consumption of the terminal device while keeping synchronization between the receive end and the transmit end.

Optionally, if the transmit end needs to send the control message to the receive end during transmitting the encoded data to the receive end by the transmit end, the transmit end may insert the control message in Table 1 into the encoded data. The control message includes the synchronization header 10, the code block type field 0x66 indicating transmission of the control message, and the control message payload.

In the data structure of the encoded data listed in Table 1, except synchronization headers, a data length of data in each cell in Table 1 is one octet (where one octet is equal to eight bits), that is, the original data includes several octets. Each control-type payload includes a code block type field that is used to indicate a type of a control-type payload following the code block type field. For example, when the code block type field is 0x87, the code block type field is used to indicate that a control-type payload following the code block type field is the termination payload 0, or when the code block type field is 0x66, the code block type field is used to indicate that a control-type payload following the code block type field is the control message payload.

In the data structure of the encoded data listed in Table 1, there are eight types of termination code blocks. The reason is as follows. The transmit end groups the original data using eight octets as one group, and there are eight cases for a quantity of remaining code blocks, that is, zero to seven octets remain. A termination code block including the remaining zero octet, the first synchronization header, and the code block type field indicating that the transmission process terminates is referred to as the termination code block 0, a termination code block including the remaining one octet, the first synchronization header, and the code block type field indicating that the transmission process terminates is referred to as the termination code block 1, and so on.

In addition, when a quantity of octets included in the control-type payload is less than 8 (that is, a quantity of bits included in the control-type payload is less than 64), several dummy bit sequences P need to be added after the control-type payload. P is a sequence including one octet, thereby implementing that a quantity of bits included in each control-type payload is the same as the quantity of bits included in the data payload, that is, both are 64.

Based on the original data with different data lengths, compositions of the encoded data when the data structure of the encoded data sent by the transmit end to the receive end is listed in Table 1 are described in the following using examples in three cases.

Case 1: When the original data is a sequence including 35 octets, the original data is grouped using eight octets as one group, four data payloads can be obtained, each data payload includes eight octets, and three octets remain. In this case, after the transmit end encodes the grouped original data, the encoded data includes four data code blocks and the termination code block 3. Each data code block includes the synchronization header 01 and the data payload (i.e., Dn, Dn+1, Dn+2, Dn+3, Dn+4, Dn+5, Dn+6, and Dn+7), and the termination code block 3 includes the synchronization header 10, the code block type field 0x4 indicating that a transmission process terminates, the remaining three octets (i.e., Dm, Dm+1, and Dm+3) after grouping is performed, and the added four dummy bit sequences P.

Case 2: When the original data is a sequence including 16 octets, the original data is grouped using eight octets as one group, two data payloads can be obtained, each data payload includes eight octets, and no octet remains after grouping is performed. In this case, after the transmit end encodes the grouped original data, the encoded data includes two data code blocks and the termination code block 0. The data code block includes the synchronization header 01 and the data payload, and the termination code block 0 includes the synchronization header 10, the code block type field 0x87 indicating that a transmission process terminates, and the added seven dummy bit sequences P.

Case 3: When the original data is a sequence including five octets, the original data is grouped using eight octets as one group, no data payload can be obtained, and five octets remain after grouping is performed. In this case, after the transmit end encodes the grouped original data, the encoded data includes only the termination code block 5. The termination code block 5 includes the synchronization header 10, the code block type field 0xd2 indicating that a transmission process terminates, the remaining five octets (i.e., Dm, Dm+1, Dm+2, Dm+3, and Dm+4) after grouping is performed, and the added two dummy bit sequences P.

EXAMPLE 2: A second data structure of the encoded data in this embodiment of this application is listed in Table 2.

TABLE 2
Second data structure of the encoded data

| | Synchronization | | | | | | | | |
|---|---|---|---|---|---|---|---|---|---|
| | header | Data payload | | | | | | | |
| Data code | 01 | Dn | Dn + 1 | Dn + 2 | Dn + 3 | Dn + 4 | Dn + 5 | Dn + 6 | Dn + 7 |
| block | | | | | | | | | |

| | Synchronization | Code block | | | | | | | |
|---|---|---|---|---|---|---|---|---|---|
| | header | type field | Control-type payload | | | | | | |
| Start code | 10 | 0x78 | D0 | D1 | D2 | D3 | D4 | D5 | D6 |
| block 0 | | | | | | | | | |
| Start code | 10 | 0x4b | P | P | P | P | P | P | P |
| block 1 | | | | | | | | | |
| Termination | 10 | 0x87 | P | P | P | P | P | P | P |
| code block 0 | | | | | | | | | |
| Termination | 10 | 0x99 | Dm | P | P | P | P | P | P |
| code block 1 | | | | | | | | | |
| Termination | 10 | 0xaa | Dm | Dm + 1 | P | P | P | P | P |
| code block 2 | | | | | | | | | |
| Termination | 10 | 0xb4 | Dm | Dm + 1 | Dm + 2 | P | P | P | P |
| code block 3 | | | | | | | | | |
| Termination | 10 | 0xcc | Dm | Dm + 1 | Dm + 2 | Dm + 3 | P | P | P |
| code block 4 | | | | | | | | | |
| Termination | 10 | 0xd2 | Dm | Dm + 1 | Dm + 2 | Dm + 3 | Dm + 4 | P | P |
| code block 5 | | | | | | | | | |
| Termination | 10 | 0xe1 | Dm | Dm + 1 | Dm + 2 | Dm + 3 | Dm + 4 | Dm + 5 | P |
| code block 6 | | | | | | | | | |
| Termination | 10 | 0xff | Dm | Dm + 1 | Dm + 2 | Dm + 3 | Dm + 4 | Dm + 5 | Dm + 6 |
| code block 7 | | | | | | | | | |
| Burst | 10 | 0x55 | 0x55 | 0x55 | 0x55 | 0x55 | 0x55 | 0x55 | 0x55 |
| termination | | | | | | | | | |
| code block | | | | | | | | | |
| Control message | 10 | 0x66 | 0x66 | UDF | UDF | UDF | UDF | UDF | UDF |
| Synchronization | 10 | 0xbf | 0x40 | 0x18 | 0xe5 | 0xc5 | 0x49 | 0xbb | 0x59 |
| mode sequence | | | | | | | | | |
| Burst delimiter | 10 | 0x6b | 0xf8 | 0xd8 | 0x12 | 0xd8 | 0x58 | 0xe4 | 0xab |
| Idle code block | 10 | 0x2d | 0 | 0 | 0 | 0 | 0 | 0 | 0 |

A difference between the data structure of the encoded data listed in Table 2 and the data structure of the encoded data listed in Table 1 lies in that the data structure of the encoded data listed in Table 2 includes a start code block, and the start code block may be used to indicate that the transmission process of the original data starts. If the data structure of the encoded data sent by the transmit end to the receive end is listed in Table 2, the encoded data includes one start code block and one termination code block in Table 2, or includes one start code block, several data code blocks, and one termination code block.

In addition, if the encoded data sent by the transmit end to the receive end uses the data structure of the encoded data listed in Table 2, burst transmission may also be performed between the transmit end and the receive end. After burst transmission terminates, the transmit end may also repeatedly send the idle code block in Table 2 to the receive end, thereby reducing power consumption of the terminal device when it is ensured that the receive end is synchronized with the transmit end. The transmit end may send the control message to the receive end when transmitting the encoded data to the receive end. For the foregoing case, details are not described herein.

Based on the original data with different data lengths, compositions of the encoded data when the data structure of the encoded data sent by the transmit end to the receive end is listed in Table 2 are described in the following using examples in four cases.

Case 1: When the original data is a sequence including 35 octets, the transmit end reserves seven octets as the reserved code block before grouping the original data. Then, the original data is grouped using eight octets as one group, three data payloads can be obtained, each data payload includes eight octets, and four octets remain. In this case, after the transmit end encodes the grouped original data, the encoded data includes the start code block 0, three data code blocks, and the termination code block 4. The start code block 0 includes the synchronization header 10, the code block type field 0x78 indicating that a transmission process starts, and the reserved code block that includes seven octets (i.e., DO, D1, D2, D3, D4, D5, and D6), the data code block includes the synchronization header 01 and the data payload, and the termination code block 4 includes the synchronization header 10, the code block type field 0xcc indicating that a transmission process terminates, the remaining four octets (i.e., Dm, Dm+1, Dm+2, and Dm+3) after grouping is performed, and the added three dummy bit sequences P.

Case 2: When the original data is a sequence including 23 octets, the transmit end reserves seven octets as the reserved code block before grouping the original data. Then, the original data is grouped using eight octets as one group, two data payloads can be obtained, and zero octet remains. In this case, after the transmit end encodes the grouped original data, the encoded data includes the start code block 0, two data code blocks, and the termination code block 0. The start code block 0 includes the synchronization header 10, the code block type field 0x78 indicating that a transmission process starts, and the reserved code block that includes seven octets, the data code block includes the synchronization header 01 and the data payload, and the termination code block 0 includes the synchronization header 10, the code block type field 0x87 indicating that a transmission process terminates, and the added seven dummy bit sequences P.

Case 3: When the original data is a sequence including 10 octets, the transmit end reserves seven octets as the reserved code block before grouping the original data. Then, the original data is grouped using eight octets as one group, no data payload can be obtained, and three octets remain. In this case, after the transmit end encodes the grouped original data, the encoded data includes the start code block 0 and the termination code block 3. The start code block 0 includes the synchronization header 10, the code block type field 0x78 indicating that a transmission process starts, and the reserved code block that includes seven octets, and the termination code block 3 includes the synchronization header 10, the code block type field 0x4 indicating that a transmission process terminates, the remaining three octets after grouping is performed, and the added four dummy bit sequences P.

Case 4: When the original data is a sequence including 5 octets, the transmit end cannot reserve seven octets as the reserved code block before grouping the original data. Then, the original data is grouped using eight octets as one group, and no data payload can be obtained. Finally, remaining five octets are used as the remaining code block. In this case, after the transmit end encodes the grouped original data, the encoded data includes the start code block 1 and the termination code block 5. The start code block 1 includes the synchronization header 10, the code block type field 0x4b indicating that a transmission process starts, and the added seven dummy bit sequences P, and the termination code block 5 includes the synchronization header 10, the code block type field 0xd2 indicating that a transmission process terminates, the remaining five octets after grouping is performed, and the added two dummy bit sequences P.

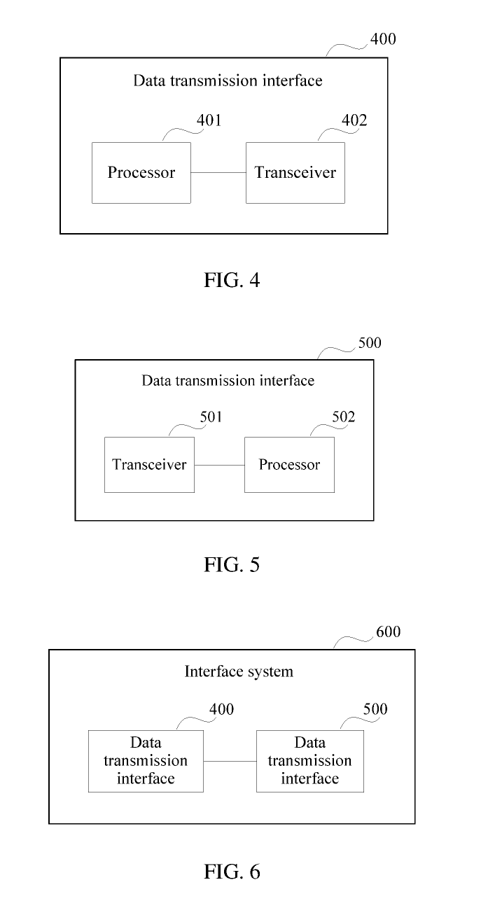

An embodiment of this application provides a data transmission interface 400, and the data transmission interface 400 may be configured to execute the operations that are executed by the transmit end in the interface data transmission method shown in FIG. 2. As shown in FIG. 4, the data transmission interface 400 includes a processor 401 and a transceiver 402.

The processor 401 is configured to encode original data to obtain encoded data, where the encoding operation includes grouping the original data.

The encoded data includes a termination code block, the termination code block is used to indicate that a transmission process of the original data terminates, and the termination code block includes a first synchronization header, a code block type field indicating that the transmission process terminates, and a termination payload. The first synchronization header is used to indicate that a payload following the first synchronization header is a control-type payload, and the termination payload is capable of carrying a remaining code block after the processor 401 groups the original data.

The transceiver 402 is further configured to send the encoded data to a receive end.

Optionally, the encoded data includes at least one data code block, the at least one code block precedes the termination code block, and each of the at least one data code block includes a second synchronization header and a data payload. The second synchronization header is used to indicate that a payload following the second synchronization header is a data-type payload, and the data payload is obtained after the processor 401 groups the original data.

Optionally, the encoded data further includes a start code block, the start code block precedes the termination code block, the start code block is used to indicate that the transmission process of the original data starts, and the start code block includes the first synchronization header, a code block type field indicating that the transmission process starts, and a start payload. The start payload is capable of carrying a code block reserved before the processor 401 groups the original data.

Optionally, after encoding the original data, the processor 401 is further configured to insert a synchronization mode sequence and a burst delimiter before the encoded data, and insert a burst termination code block after the encoded data, to obtain burst transmission data. The synchronization mode sequence is used to implement synchronization of an interface system, the burst delimiter is used to indicate that a burst transmission process of the original data starts, and the burst termination code block is used to indicate that the burst transmission process of the original data terminates. The transceiver 402 is further configured to send the burst transmission data to the receive end when sending the encoded data to the receive end.

Optionally, after encoding the original data, the processor 401 is further configured to perform scrambling process on the encoded data using a preset scrambling code.

Optionally, the processor 401 is further configured to insert a control message into the encoded data. The control message includes the first synchronization header, a code block type field indicating transmission of the control message, and a control message payload.

Optionally, the code block type field that is in the termination code block and that indicates that the transmission process terminates is further used to indicate a length of the remaining code block.

Optionally, when the length of the remaining code block is less than a length of the termination payload, the termination payload is further used to carry at least one dummy bit sequence.

In the data transmission interface 400 shown in FIG. 4, because the encoded data sent by the transceiver 402 to the receive end includes the termination code block, when starting to receive the encoded data, the receive end can acquire that the transmission process of the original data starts, and when receiving the termination code block included in the encoded data, the receive end can acquire that the transmission process of the original data terminates. Therefore, a start and stop location of the original data in the encoded data can be delimited using the data transmission interface 400 provided in FIG. 4 such that after receiving the encoded data, the receive end can accurately restore, according to the start and stop location of the original data, the original data sent by the transmit end.

The data transmission interface 400 shown in FIG. 4 may be configured to execute the operations that are executed by the transmit end in the interface data transmission method shown in FIG. 2. For implementations of the data transmission interface 400 that are not explained and described in detail, refer to related descriptions in the interface data transmission method shown in FIG. 2.

An embodiment of this application provides a data transmission interface 500, and the data transmission interface 500 may be configured to execute the operations that are executed by the receive end in the interface data transmission method shown in FIG. 2. As shown in FIG. 5, the data transmission interface 500 includes a transceiver 501 and a processor 502.

The transceiver 501 is configured to receive encoded data sent by a transmit end in an interface system.

The encoded data includes a termination code block, the termination code block is used to indicate that a transmission process of original data corresponding to the encoded data and that is from the transmit end terminates, and the termination code block includes a first synchronization header, a code block type field indicating that the transmission process terminates, and a termination payload. The first synchronization header is used to indicate that a payload following the first synchronization header is a control-type payload, and the termination payload is capable of carrying a remaining code block after the transmit end groups the original data when encoding the original data.

The processor 502 is configured to acquire, by identifying the termination code block included in the encoded data received by the transceiver 501, that the transmission process of the original data terminates, and obtain, according to an indication of the code block type field that is included in the termination code block and that indicates that the transmission process terminates, the remaining code block carried in the termination payload, as the original data.

Optionally, the encoded data includes at least one data code block, the at least one code block precedes the termination code block, and each of the at least one data code block includes a second synchronization header and a data payload. The second synchronization header is used to indicate that a payload following the second synchronization header is a data-type payload, and the data payload is obtained after the transmit end groups the original data.

The processor 502 is further configured to obtain at least one data payload according to an indication of the second synchronization header that is included in each of the at least one data code block before acquiring, by identifying the termination code block, that the transmission process of the original data terminates, and when using the remaining code block as the original data, the processor 502 is further configured to combine the at least one data payload and the remaining code block to obtain the original data.

Optionally, the encoded data further includes a start code block, the start code block precedes the termination code block, the start code block is used to indicate that the transmission process of the original data starts, and the start code block includes the first synchronization header, a code block type field indicating that the transmission process starts, and a start payload. The start payload is capable of carrying a code block reserved before the transmit end groups the original data. The processor 502 is further configured to acquire, by identifying the start code block, that the transmission process of the original data starts, and obtain, according to an indication of the code block type field that is included in the start code block and that indicates that the transmission process starts, a reserved code block carried in the start payload after the transceiver 501 receives the encoded data, and the processor 502 is further configured to combine the reserved code block and the remaining code block to obtain the original data when using the remaining code block as the original data.

Optionally, when receiving the encoded data, the transceiver 501 is further configured to receive burst transmission data. The burst transmission data includes a synchronization mode sequence, a burst delimiter, the encoded data, and a burst termination code block. The synchronization mode sequence is used to implement synchronization of the interface system, the burst delimiter is used to indicate that a burst transmission process of the original data starts, and the burst termination code block is used to indicate that the burst transmission process of the original data terminates.

Optionally, the processor 502 is further configured to perform descrambling process on the encoded data using a preset descrambling code.

Optionally, when receiving the encoded data, the transceiver 501 is further configured to receive the encoded data into which a control message is inserted. The control message includes the first synchronization header, a code block type field indicating transmission of the control message, and a control message payload. The processor 502 is further configured to obtain the control message payload according to an indication of the code block type field indicating transmission of the control message.

Optionally, the code block type field that is in the termination code block and that indicates that the transmission process terminates is further used to indicate a length of the remaining code block.

Optionally, when the length of the remaining code block is less than a length of the termination payload, the termination payload is further used to carry at least one dummy bit sequence.

In the data transmission interface 500 shown in FIG. 5, because the encoded data received by the transceiver 501 includes the termination code block, when the transceiver 501 starts to receive the encoded data, the processor 502 can acquire that the transmission process of the original data starts, and when the transceiver 501 starts to receive the termination code block included in the encoded data, the processor 502 can acquire that the transmission process of the original data terminates. Therefore, according to the interface data transmission method provided in FIG. 5, the processor 502 can delimit a start and stop location of the original data in the encoded data such that after the transceiver 501 receives the encoded data, the processor 502 can accurately restore, according to the start and stop location of the original data, the original data sent by the transmit end.

The data transmission interface 500 shown in FIG. 5 may be configured to execute the operations that are executed by the receive end in the interface data transmission method shown in FIG. 2. For implementations of the data transmission interface 500 that are not explained and described in detail, refer to related descriptions in the interface data transmission method shown in FIG. 2.

An embodiment of this application provides an interface system 600. As shown in FIG. 6, the interface system 600 includes the data transmission interface 400 shown in FIG. 4 and the data transmission interface 500 shown in FIG. 5. When the data transmission interface 400 is a baseband chip in a terminal device, the data transmission interface 500 is a radio frequency chip in the terminal device, or when the data transmission interface 400 is a radio frequency chip in a terminal device, the data transmission interface 500 is a baseband chip in the terminal device. The data transmission interface 400 in the interface system 600 shown in FIG. 6 may be configured to execute the operations that are executed by the transmit end in the interface data transmission method shown in FIG. 2, and the data transmission interface 500 in the interface system 600 shown in FIG. 6 may be configured to execute the operations that are executed by the receive end in the interface data transmission method shown in FIG. 2.

In the interface data transmission method, the data transmission interface, and the interface system that are provided in the embodiments of this application, because the encoded data sent by the transmit end to the receive end includes the termination code block, when starting to receive the encoded data, the receive end can acquire that the transmission process of the original data starts, and when receiving the termination code block included in the encoded data, the receive end can acquire that the transmission process of the original data terminates. Therefore, according to the interface data transmission method provided in the embodiments of this application, a start and stop location of the original data in the encoded data can be delimited such that after receiving the encoded data, the receive end can decode the encoded data according to the start and stop location of the original data in order to accurately restore the original data sent by the transmit end.

A person skilled in the art should understand that, either the interface 400 or the interface 500 according to the embodiments of this application, that is, a processor in the transmit end or the receive end, may be a processor in hardware, for example, a logic circuit, including multiple transistors. The hardware processor is configured to implement an encoding operation of the transmit end or a decoding operation of the receive end. Alternatively, a processor may be a processor that executes software code. Therefore, a form of hardware only embodiments, software only embodiments, or embodiments with a combination of software and hardware may be used in the method according to the embodiments of this application. The software code may be understood as a computer program product. In addition, a form of a computer program product that is implemented on one or more computer-usable storage media (including but not limited to a magnetic disk memory, a compact disc read-only memory (CD-ROM), and an optical memory) including computer usable program code may be used in the embodiments of this application.

Obviously, a person skilled in the art can make various modifications and variations to the embodiments of this application without departing from the spirit and scope of the embodiments of the present disclosure. This application is intended to cover these modifications and variations provided that they fall within the scope of protection defined by the following claims and their equivalent technologies.

1. A method for sending interface data, comprising:
encoding original data to obtain encoded data, wherein encoding comprises grouping the original data, wherein the encoded data comprises a termination code block indicating that a transmission process of the original data terminates, wherein the termination code block comprises a first synchronization header, a code block type field indicating that the transmission process terminates, and a termination payload, wherein the first synchronization header indicates that a payload following the first synchronization header comprises a control-type payload, and wherein the termination payload is capable of carrying a remaining code block after the original data is grouped; and
sending the encoded data to a receive end in an interface system.

2. The method according to claim 1, wherein the encoded data further comprises at least one data code block, wherein the at least one data code block precedes the termination code block, wherein each of the at least one data code block comprises a second synchronization header and a data payload, wherein the second synchronization header indicates that a payload following the second synchronization header comprises a data-type payload, and wherein the data payload is obtained after the original data is grouped.

3. The method according to claim 1, wherein the encoded data further comprises a start code block, wherein the start code block precedes the termination code block and indicates that the transmission process of the original data starts, wherein the start code block comprises the first synchronization header, a code block type field indicating that the transmission process starts, and a start payload, and wherein the start payload is capable of carrying a code block reserved before the original data is grouped.

4. The method according to claim 1, wherein after encoding the original data, the method further comprises:
inserting a synchronization mode sequence and a burst delimiter before the encoded data; and
inserting a burst termination code block after the encoded data to obtain burst transmission data,
wherein the synchronization mode sequence implements synchronization of the interface system,
wherein the burst delimiter indicates that a burst transmission process of the original data starts,
wherein the burst termination code block indicates that the burst transmission process of the original data terminates, and
wherein sending the encoded data to the receive end comprises sending the burst transmission data to the receive end.

5. The method according to claim 1, wherein after encoding the original data, the method further comprises performing scrambling process on the encoded data using a preset scrambling code.

6. The method according to claim 1, further comprising inserting a control message into the encoded data, and wherein the control message comprises the first synchronization header, a code block type field indicating transmission of the control message, and a control message payload.

7. The method according to claim 1, wherein the code block type field in the termination code block further indicates a length of the remaining code block.

8. The method according to claim 7, wherein the termination payload further carries at least one dummy bit sequence when the length of the remaining code block is less than a length of the termination payload.

9. A method for receiving interface data, comprising:
receiving encoded data from a transmit end in an interface system, wherein the encoded data comprises a termination code block indicating that a transmission process of original data corresponding to the encoded data from the transmit end terminates, wherein the termination code block comprises a first synchronization header, a code block type field indicating that the transmission process terminates, and a termination payload, wherein the first synchronization header indicates that a payload following the first synchronization header comprises a control-type payload, and wherein the termination payload is capable of carrying a remaining code block after the transmit end performs grouping when encoding the original data;
acquiring, by identifying the termination code block comprised in the encoded data, that the transmission process of the original data terminates; and
obtaining, according to an indication of the code block type field comprised in the termination code block indicating that the transmission process terminates, the remaining code block carried in the termination payload, as the original data.

10. The method according to claim 9, wherein the encoded data further comprises at least one data code block, wherein the at least one data code block precedes the termination code block, wherein each of the at least one data code block comprises a second synchronization header and a data payload, wherein the second synchronization header indicates that a payload following the second synchronization header comprises a data-type payload, wherein the data payload is obtained after the transmit end groups the original data, and wherein the method further comprises:
obtaining at least one data payload according to an indication of the second synchronization header comprised in each of the at least one data code block; and
combining the at least one data payload and the remaining code block to obtain the original data.

11. A data transmission interface, comprising:
a processor configured to encode original data to obtain encoded data, wherein encoding comprises grouping the original data, wherein the encoded data comprises a termination code block indicating that a transmission process of the original data terminates, wherein the termination code block comprises a first synchronization header, a code block type field indicating that the transmission process terminates, and a termination payload, wherein the first synchronization header indicates that a payload following the first synchronization header comprises a control-type payload, and wherein the termination payload is capable of carrying a remaining code block after the processor groups the original data; and
a transceiver coupled to the processor and configured to send the encoded data to a receive end in an interface system.

12. The data transmission interface according to claim 11, wherein the encoded data further comprises at least one data code block, wherein the at least one data code block precedes the termination code block, wherein each of the at least one data code block comprises a second synchronization header and a data payload, wherein the second synchronization header indicates that a payload following the second synchronization header comprises a data-type payload, and wherein the data payload is obtained after the processor groups the original data.

13. The data transmission interface according to claim 11, wherein the encoded data further comprises a start code block, wherein the start code block precedes the termination code block and indicates that the transmission process of the original data starts, wherein the start code block comprises the first synchronization header, a code block type field indicating that the transmission process starts, and a start payload, and wherein the start payload is capable of carrying a code block reserved before the processor groups the original data.

14. The data transmission interface according to claim 11, wherein after encoding the original data, the processor is further configured to:
insert a synchronization mode sequence and a burst delimiter before the encoded data; and
insert a burst termination code block after the encoded data to obtain burst transmission data,
wherein the synchronization mode sequence implements synchronization of the interface system,
wherein the burst delimiter indicates that a burst transmission process of the original data starts,
wherein the burst termination code block indicates that the burst transmission process of the original data terminates, and
wherein the transceiver is further configured to send the burst transmission data to the receive end when sending the encoded data to the receive end.

15. The data transmission interface according to claim 11, wherein after encoding the original data, the processor is further configured to perform scrambling processing on the encoded data using a preset scrambling code.

16. The data transmission interface according to claim 11, wherein the processor is further configured to insert a control message into the encoded data, and wherein the control message comprises the first synchronization header, a code block type field indicating transmission of the control message, and a control message payload.

17. The data transmission interface according to claim 11, wherein the code block type field in the termination code block further indicates a length of the remaining code block.

18. The data transmission interface according to claim 17, wherein the termination payload further carries at least one dummy bit sequence when the length of the remaining code block is less than a length of the termination payload.

19. A data transmission interface, comprising:
a transceiver configured to receive encoded data from a transmit end in an interface system, wherein the encoded data comprises a termination code block indicating that a transmission process of original data corresponding to the encoded data from the transmit end terminates, wherein the termination code block comprises a first synchronization header, a code block type field indicating that the transmission process terminates, and a termination payload, wherein the first synchronization header indicates that a payload following the first synchronization header comprises a control-type payload, and wherein the termination payload is capable of carrying a remaining code block after the transmit end performs grouping when encoding the original data; and
a processor coupled to the transceiver and configured to:
acquire, by identifying the termination code block comprised in the encoded data, that the transmission process of the original data terminates; and
obtain, according to an indication of the code block type field comprised in the termination code block indicating that the transmission process terminates, the remaining code block carried in the termination payload, as the original data.

20. The data transmission interface according to claim 19, wherein the encoded data further comprises at least one data code block, wherein the at least one data code block precedes the termination code block, wherein each of the at least one data code block comprises a second synchronization header and a data payload, wherein the second synchronization header indicates that a payload following the second synchronization header is a data-type payload, wherein the data payload is obtained after the transmit end groups the original data, and wherein the processor is further configured to:
obtain at least one data payload according to an indication of the second synchronization header comprised in each of the at least one data code block; and
combine the at least one data payload and the remaining code block to obtain the original data when using the remaining code block as the original data.
